(19) United States
(12) Patent Application Publication
(10) Pub. No.: US 2019/0284513 A1
(43) Pub. Date: Sep. 19, 2019

(54) FATTY ACID SOAP BARS PREPARED FROM OIL STOCK OF LOW IV COMPRISING POTASSIUM SOAP

(71) Applicant: Conopco, Inc., d/b/a UNILEVER, Englewood Cliffs, NJ (US)

(72) Inventors: Rafael ASTOLFI, São Paulo (BR); Sergio Roberto LEOPOLDINO, São Paulo (BR); Enio Mitsuki OURA, São Paulo (BR); Georgia L. SHAFER, Southbury, CT (US); Yuriy Konstantinovich YAROVOY, Monroe, CT (US)

(73) Assignee: Conopco, Inc., d/b/a UNILEVER, Englewood Cliffs, NJ (US)

(21) Appl. No.: 16/071,528

(22) PCT Filed: Jan. 19, 2017
(86) PCT No.: PCT/EP2017/051118

§ 371 Date: Jul. 20, 2018

(30) Foreign Application Priority Data
Jan. 26, 2016 (EP) 16152824.5

(51) Int. Cl. C11D 9/02; C11D 9/00; C11D 13/18; C11D 17/00

(52) U.S. Cl. CPC C11D 9/02; C11D 17/006; C11D 13/18; C11D 9/007

(57) ABSTRACT

The present invention relates to predominantly (50% or greater) soap bars made from oil or oils of defined iodine value. Unexpectedly, it has been found that, when defined amounts of potassium soap are used, bars made from oils falling within the defined IV range have excellent extrusion rates (as defined by falling within defined hardness values) without exhibiting excessive cracking, while exhibiting wear and mush values associated with lower IV and surprising lather values not expected from bars made from lower IV oils. This is a unique and unexpected simultaneous accumulation of attributes. Further, unexpected perfume performance (e.g., bloom) is also found.

### FIELD OF THE INVENTION

The invention relates to bars which are predominantly (50% or greater by wt.) fatty acid soap bar compositions. To ensure high throughput production of bars upon extrusion, fatty acid soaps (formed from saponification of oils) should neither be too soft (clogging machinery), nor too hard (diminishing extrusion rates due to lower plasticity and/or compromising final bar products due to severe cracking). The properties of the saponified soaps in turn depend on the selection of the oil blend forming the soaps. The oil blend can also be important in determining other properties (e.g., lather, rate of wear, mush) upon soap extrusion and production of final bar.

The invention relates to bars prepared from oil stock of low IV (which bars are typically harder than bars of higher IV) wherein there is present a specific window of potassium soap.

Surprisingly it has been found that soap bars can be made from starting oils (e.g., the triglycerides used to make soap) having iodine values (IV)(a measure of average level of unsaturated fatty acid chains making up the triglycerides) which are low enough to maintain high extrusion rates while simultaneously maintaining excellent user properties (good lather; lower cracking); typically, bars with higher IV (higher level of unsaturation) have these superior user properties, but do not have high throughput extrusion (e.g., because they are too soft). Surprisingly, by providing a specific window of potassium soap to bars prepared from oils of defined IV (based on overall weight of bar compositions), bars having hardness values which provide ideal extrusion rates can be prepared while simultaneously maintaining good lather and avoiding low cracking (both traits associated with higher IV stock). Further, since use of higher IV is avoided, wear rates are enhanced. Moreover, all of this is done with bars having water levels of 13 to 25% by wt., preferably 14 to 22%, more preferably 15 to 20%, even more preferably 16 to 18% are used. The water range in which the production (extrusion and stamping) of ordinary extruded soap bars is conducted is typically problematic because of potential problems of excessive softness and stickiness if water ranges are not carefully selected.

### BACKGROUND OF THE INVENTION

Soap bars for cleansing are typically prepared by direct saponification of fats and oils or by neutralization of free fatty acids. In the saponification process, various fats (e.g., tallow, palm and/or coconut oil blends) are saponified in the presence of alkali (usually NaOH) to yield alkaline salts of fatty acids (derived from the fatty acid chains forming the glyceride) and glycerol. Glycerol is then typically extracted with brine to yield dilute fatty acid soap solution containing soap (soaps formed after saponification and before extrusion to final bar are referred to often as soap “noodles”) and aqueous phase (e.g., 70% soap and 30% aqueous phase). The soap solution is then typically dried (e.g. to about 16% water) and the remaining mass is typically mixed, milled, plodded (e.g., by extruding the soap noodles through a nosecone), cut and stamped into bars.

The chain length of fatty acid soaps varies depending on starting fat or oil feedstock (for purposes of this specification, “oil” and “fat” are used interchangeably, except where context demands otherwise). Longer chain fatty acid soaps (e.g., C₁₆ palmitic or C₁₈ stearic) are typically obtained from tallow and palm oils, and shorter chain soaps (e.g., C₁₂ lauric) may typically be obtained from, for example, coconut oil or palm kernel oil. The fatty acid soaps produced may also be saturated or unsaturated (e.g., oleic acid).

Typically, longer molecular weight fatty acid soaps (e.g., C₁₄ to C₂₂ soaps) especially longer, saturated soaps are insoluble and do not generate good foam volumes, despite the fact that they can help making the foam generated by other soluble soaps creamier and more stable. Conversely shorter molecular weight soaps (e.g., C₈ to C₁₂) and unsaturated soaps (e.g., oleic acid soap) lather quickly. However, the longer chain soaps (typically saturated, although they may also contain some level of unsaturated such as oleic) are desirable in that they maintain structure and do not dissolve as readily. Unsaturated soaps (e.g., oleic) are soluble and lather quickly, like short-chained soaps, but form a denser, creamier foam, like the longer chained soaps.

Typically a bar which is formed by a so-called extruded bar process (rather than bars which are formed, for example, by a cast melt process where ingredients are poured into a mold and are then cooled or are allowed to cool until bar hardens and forms) should be formed from soaps of sufficient hardness (not too mushy as to clog machinery or too non-plastic as to slow rate of production and cause cracking) so the soaps can be extruded at a sufficiently high rate to justify the economics of the bar production. Typically, we define such rate to be at least 200 bars/minute, preferably in excess of 300 bars/minute. To meet the defined extrusion rate standard, applicants have defined a bar hardness which must be met. Typically the hardness value is between about 3 and 5 kilogram when measured at 40° C. using 15 mm penetration. Measurement of hardness is a measurement of the final bar product after extrusion. Typically, such measurement is taken right after the extrusion.

The hardness of the final bar correlates with the iodine value of the oil forming the soap. Oils and fats which have a high average level of unsaturation are said to have high iodine value; and oils and fats which have a low average level of unsaturation are said to have low iodine value. Typically, bars made from oils with higher iodine value (more unsaturated) are softer and those made from oils with low IV value (more saturated) are harder. Iodine value is a well-known standard for measuring unsaturation and measurement of IV is well known and understood. One well known method, for example, is use of gas chromatography. Using this method, methyl esters of the fatty acid chains in the oil are formed and methyl esters of the fatty acids are analysed by gas chromatography. As noted, this is well known in the art.

We have found that the measured hardness value range of the final bar, as defined, correlates with saponified soaps which are neither too soft (to clog machinery), nor too hard (forming bars with potential cracking issues) and therefore is a hardness range which permits high throughput extrusion. In preparing bars falling within defined hardness value range (and providing correlated high throughput extrusion), applicants have focused always on the IV values of starting oil and never on the distribution of soaps (e.g., amounts and types of soaps) made after saponification of the oils. Typically, to form soaps of sufficient plasticity such that they are not so soft as to clog and have low extrusion, nor so hard as to cause severe cracking of finished bars, starting oils of IV 37 to 43, preferably 38 to 43 are used.

It would be theoretically advantageous, however, to use starting materials with even lower IV (i.e., oils which are lower in unsaturates and form less plastic (“harder”) soaps both because lower IV oils are typically cheaper and because, using harder soaps, one would expect to form bars which have a lower rate of wear and form less mush on bar use. However, using lower IV oils, it would also be expected that the saponified soaps would form final bars providing less lather. Further, absent any guidance as to saponification (e.g., whether to saponify with any particular counterions or produce any particular amount of potassium soaps or sodium soaps), it would be expected that the saponified soaps formed would be too hard and causes severe cracking. For example, using soap noodles made from oils having IV of 32, saponified with 100% NaOH (i.e., there is 0% potassium soap), results in bars having hardness values of above 5 Kg (when measuring final bar at 40° C. using 15 millimeter penetration). Results in Table 2 of examples which follow confirm this. Extruded bars made from such soaps demonstrate severe cracking.

Unexpectedly, applicants have found that, by specifically saponifying oils so that 5% to 15% of potassium soap noodles are formed (as percent of total bar composition), starting oils having IV 37 or below (e.g., 0-37, preferably 2-36, preferably 10-35, more preferably 25-35 even more preferably 30-35) can be used; and the final bars obtained, when resulting soap noodles are extruded, have hardness of 3.0 to 5.0 kg measured at 40° C. and crack values of 0 to 3, as defined in our protocol. A person of ordinary skill in the art would expect bars made from oils of such lower IV to have severe cracking (e.g., be outside our hardness range). Indeed, if oils of lower IV are saponified to obtain an amount of potassium soap outside the defined 5 to 15% potassium soap range, the ideal hardness range of bars produced by our invention typically would not necessarily be obtained and correlated extrusion rates (without at the same time experiencing severe cracking) are also not necessarily obtained.

Moreover, because soaps (and extruded final bars) are produced with oils of lower IV (lower unsaturated, harder oils), the bars have a lower rate of wear (longer lasting) and have mush values generally lower than the bars produced starting with oils of higher IV (e.g., above 37). Thus, cheaper oils of lower IV can be used to make soaps which can be extruded at excellent rates (greater or equal to 200 bars/minute) without experiencing severe cracking issues, while taking advantage of lower rate of wear and lower mush values associated with the use of such lower IV oils.

In addition, it has been quite unexpectedly found that saponifying the lower IV oils to form 5% to 15% potassium soap allows production of bars with enhanced lather relative to bars produced using oils having the same IV, but saponified to form 100% sodium soap (e.g., less than 5% potassium soap as percent of original bar). Indeed, the lather levels are comparable to bars made from oils having IV of 39 and saponified to form 100% sodium soap. This is particularly surprising as better lather is usually associated only with the use of such higher IV starting oils.

If starting with oils on the higher side of the range (i.e., range of 0 to 37), less potassium soaps (within the 5 to 15% range) is needed and, if starting with lower IV oils, more potassium soap should be used (i.e., to ensure target hardness value is met). For example, for oil with IV on the higher side (e.g., 30 to 35), typically 5 to 10% potassium soap should be formed; and, for oils of lower IV (5-9), typically, 10 to 14% potassium soap should be formed. Since oil blends have different distribution of saturated and unsaturated carbon chain lengths and different distribution of shorter or longer chain length (e.g., tallow oils, palm oil and palm stearine oil have a greater number of chains with unsaturates and typically longer chain lengths; conversely coconut oil and palm kernel oils have fewer carbon chains with unsaturates and typically shorter chain lengths), the amount of postassium soap formed (within 5 to 15% range) may vary slightly even for oil blends having the same average IV values. It is simple to define these small variations by forming a bar having selected amount of potassium soap within the range, and callibrating based on measured result from the hardness value test.

Stated differently, even though average IV of the starting oil or oils may be the same, if the ratio of oils within the starting oil mixture to be saponified varies (e.g., 90/10 tallow oil to coconut versus 80/20) the exact level of potassium soap to be formed on saponification may vary slightly. 90/10 tallow to coconut oil, for example, typically has more long chain length oils relative to a bar made from 80/20 tallow to coconut oil; and, if saponified to form 100% of sodium soap, for example, would form soaps less plastic (“harder”) than those produced from 80/20 oil. As such, even though the IV of both oil blends may be the same, more potassium soap (8% vs. 7%) may be required to ensure bar made from soaps saponified from 90/10 oil falls within defined hardness range than to ensure bar made from soaps saponified from 80/20 oil fall into the range. The amount of potassium needed can be simply determined by those skilled in the art, however, callibrating with hardness value test. Thus, although not every amount in the range of 5-15% potassium soap will ensure bars made from oils having IV of 0-37 fall within hardness ranges of final measured bar (since, as noted, it depends on ratio of starting oils), it is simple to determine that part of the range (e.g., within 5-15% range) for any particular blend of oils.

It should be noted that while differences (requiring slightly different levels of potassium soap) can be observed where ratios of characteristically longer chain oils (e.g., tallow, palm stearine, palm) and those of characteristically shorter chain oils (coconut, palm kernel) are varied (90/10 versus 80/20), the differences in chain length among the longer chain or shorter chain oils is not sufficient to provide any significant difference if substituting one longer chain oil or one shorter chain oil for another. Thus, for example, for oil mixture of the same average IV, the amount of potassium soaps used is substantially the same whether oils are 90/10 ratio of tallow to coconut, 90/10 ratio of palm stearine oil (PSO) to coconut, 90/10 ratio of tallow to palm kernel oil or 90/10 ratio of palm stearine oil to palm kernel oil. For purposes of the invention, tallow, PSO and PO can be used interchangably; and coconut and palm kernel and can also be used interchangabley.

Applicants have also surprisingly found that in bars comprising fragrance and made from lower IV oils which have been saponified to form 5% to 15% potassium soap (relative to bars comprising fragrance and made from oils of higher IV but saponified such that no potassium soaps are formed), the headspace over the bar (e.g., concentration of fragrance in static headspace over solid soap as defined in the protocol) and headspace over the diluted bar (e.g., the amount of fragrance in static headspace above diluted soap slurry as defined in protocol) is significantly enhanced.

No art of which applicants are aware recognizes that the amount and the type of saponification (e.g., oils of defined IV are saponified to form 5 to 15% potassium soap as percent of total bar weight) can allow a formulator to select lower average IV starting oil while obtaining simultaneous high throughput in the absence of severe cracking, and sensory benefit not presumably believed to be able to simultaneously obtain (e.g., wear and mush benefits of low IV and lather levels of higher IV). The formulator may thus select, for example, oils having lower average IV (e.g., which are lower cost) while obtaining high throughput extrusion (e.g., correlated with a measured hardness value of resulting bars of 3 to 5 Kg measured at 40° C. using 15 mm penetration standard when bars are measured right after extrusion) while avoiding cracking issues that are typically associated when bars made using these lower IV oils are used as starting materials. Moreover, using the lower IV oil, one can obtain lower rate of wear, lower mush, while surprisingly maintaining lather values comparable to if higher IV oils had been used as starting materials.

The invention relates both to novel bars and to a process of making the bars. The bars have high throughput extrusion (as defined) while avoiding cracking problems and have excellent consumer properties. Bars of the invention are made using low average IV oils or oil blends (IV 0 to 37, preferably 2 to 36, more preferably 10 to 35) as starting materials. The process comprises providing oil or oils having IV of 0 to 37, saponifying the oil or oils to produce 5 to 15% potassium soap as percent total bar (balance of soaps in the final bar may be, for example, sodium soaps), and extruding resulting soap noodles to form final bars. At level of above 15% potassium soap, the extruded mass would typically be too soft and not suitable for industrial processing. As noted above, within the range of 5 to 15% potassium soap, the exact amount required to ensure final bars fall within defined hardness range is readily determined.

No art of which applicants are aware discloses specifically using specifically oils of IV 0 to 37 saponified specifically with 5 to 15% potassium oils. Neither do they recognize that, using specific criteria, bars of defined hardness (3.0 to 5.0 Kg measured at 40° C.), ideal for extrusion, and still without severe cracking are obtained. The combination of good lather (from use of postassium), good wear and low cracking is highly unexpected.

### BRIEF DESCRIPTION OF THE INVENTION

The invention comprises a soap bar composition (preferably comprising 50 or greater to 90% by wt. soap) comprising 5% to 15% by wt. potassium soap (by wt. of total bar). Balance of the soap in the bar may be, for example, sodium soap.

Said soap bar has hardness of 3 to 5 Kg when measured at 40° C. using 15 mm penetration directly after extrusion and cracking value of 0 to 3 as defined in protocol.

Further, bars of invention preferably have water level of 13 to 25%, preferably 14 to 22%, more preferably 15 to 20%, even more preferably 16 to 18%. Higher levels of water in bars are typically associated with reduced total fatty matter (TFM) which is advantageous for mildness and delivery of benefit actives. However, such higher levels of water are typically not practical for ordinary extruded bars because of excessive softness and stickiness which occurs at such high levels.

Preferably, said bar is extruded from soap noodles wherein the extruded noodles are saponified from starting oil or oils having an average iodine value of 0 to 37 (the exact amount of potassium soap measured to form with the 5 to 15% range depends on the IV of the starting oil or oil blends within the 0 to 37 range; and, in part, on the composition of the blend (e.g., ratio of tallow to coconut)). This amount is readily determined by one skilled in the art, for example, using simple a iterative process where the hardness of final bar is used to calibrate whether slightly more or less potassium soap needs to form to ensure hardness falls within defined value.

Preferably, oils saponified include those selected from the group consisting of tallow and coconut oils, as defined herein. As noted, for purposes of our invention, tallow oil, palm oil (PO) and palm stearine oil (PSO) each function substantially the same as long as these characteristically long chain oils have the same IV and the ratio of these oils to characteristically short chain oils stays the same. Similarly, coconut oil and palm kernel oil (PKO) function substantially the same as long as they have same IV and the ratio of characteristically longer chain oil to these shorter oils stays the same. In one embodiment, bars having 5 or 6 or 7% potassium soap (as weight percent of final bar) on lower range to 10 or 11 or 12 or 13% potassium soap on upper range, and wherein ratio of tallow oil to coconut oil is 78/22 to 82/18 (starting oils prior to saponification) are preferred. More specifically, in one form, bars having 5 to 12% potassium soap and made from oils wherein ratio of PSO to PKO is 78/22 to 82/18 are preferred. In another form, bars have 5 to 9% potassium soap and ratio of starting tallow oil to coconut oil (or of PSO to PKO) is 82/18 to 88/12. In another form, bars have 8 to 12% potassium soap and ratio of tallow to coconut (or of PSO to PKO) is 87/13 to 93/7.

Because we are saponifying starting fatty oils and/or neutralizing fatty acids to form 5% to 15% potassium soaps (using, for example, potassium hydroxide), and preferably balance sodium soaps, it is possible to use starting oils having IV 0 to 37 (preferably 2 to 36, preferably 10 to 35 or 25 to 35), with good bar hardness (which is defined by hardness level within a defined range; in this range soap are extrudable at extrusion rate producing 200 or greater bars/minute), and simultaneously avoiding excessive cracking (cracking index is 0 to 3). When starting oils of lower IV are used and noted potassium levels are not used, the bars reach a level of 4 or 5 on a cracking scale of 0 to 5 (“cracking index”) and such bars are considered unacceptable.

Further, because we are using low average IV oils (which are less expensive than higher IV oils), it is possible to obtain bars within defined hardness range which also have a lower rate of wear and lower mush as is associated with use of such lower IV oils. Moreover, we have surprisingly found the bars foam as well as bars made from starting oils of IV above 37. It is believed this is due to use of potassium counterions.

As noted, the bars made from soaps in turn made from these lower range IV oils which are saponified to form 5% to 15% potassium soap have superior properties; these include lower wear rate and lower mush values than bars made from soaps which were in turn made from higher IV oils or made from oils with the same IV but saponified to form, for example, 100% sodium soaps. In addition, quite unexpectedly, the bars have lather comparable to bars made from more expensive, higher IV oils. Further, in another aspect of the invention, the bars of the invention provide superior perfume headspace of perfume ingredients over said bar, as well as superior headspace over diluted bar, compared to bars made from oils of higher IV.

All in all, the unexpected effects observed based on saponificaiton to form 5% to 15% potassium soap are quite remarkable. Specifically, to have bars which simultaneously extrude well (defined hardness values), have acceptable cracking, have excellent wear and mush rate and lather well is remarkable.

The process of forming such bars with these simultaneous properties by selecting oils of lower IV (0 to 37), saponifying to ensure production of 5% to 15% potassium soaps (as weight percent final bars), and extruding to form final bar (falling within defined hardness range) is also contemplated.

### BRIEF DESCRIPTION OF THE FIGURES

In FIG. 1 we see that saponification of oils having IV of 32 to produce bars having 7% or 10% potassium soap (Examples 5, 6, 8, 9, 11 and 12) resulted in bars with lather comparable or superior to the lather formed from bars produced from starting oils having IV 39 (Example A-C) and having no potassium soap (Examples 4, 7 and 10). Since bars with high unsaturates generally foam better than bars with high saturates (e.g., bars made from oils with starting IV 39 would be expected to foam better than those from oils with starting IV 32), this shows the truly unexpected nature of forming bars having 5 to 15% potassium soap when prepared from oil stock of low IV.

In FIGS. 2 and 3, it's possible to observe that, unexpectedly, the blend of oils with low unsaturates (e.g. bars with IV 32 or lower) generated potassium soap bars of our invention having lower rate of wear and lower mush. FIGS. 2 and 3 show that we can create bars with a hardness profile such as to have good high throughput production (e.g., falling within our defined hardness range and having acceptable cracking) even though bars are made from oils of IV 32 (Tables 1 and 2 in Examples); further, this is done while retaining the noted beneficial properties (good wear, low mush) associated with lower IV oils.

In other words, bars made from oils of this IV would normally have hardness value outside our defined desired level. According to our invention, we can reduce hardness (using specific amount of potassium soap) to ensure final bars have measured values which fall within our defined hardness window and have acceptable cracking, all while retaining lower wear and lower mush values associated with bars made from these oils of the lower IV.

FIG. 4 defines a cracking scale of 0 to 5 and accompanying photos showing cracks associated with defined numbers. It is noted the test is done following the rate of wear condition simulations defined in the protocol. Both are done directly following extrusion. As these tests simulate extremely heavy use and wear, which is activity most consumers may never match, cracking scores up to a level of 3 are considered acceptable for purpose of our invention.

### DETAILED DESCRIPTION OF THE INVENTION

Except in the examples, or where otherwise explicitly indicated, all numbers in this description indicating amounts of material or conditions of reaction, physical properties of materials and/or use are to be understood as modified by the word “about.”

As used throughout, ranges are used as shorthand for describing each and every value that is within the range. Any value within the range can be selected as terminus of the range.

The use of and/or indicates that any one from the list can be chosen individually, or any combination from the list can be chosen.

For the avoidance of doubt, the word “comprising” is intended to mean “including” but not necessarily “consisting of” or “composed of.” In other words, the listed steps or options need not be exhaustive.

Unless indicated otherwise, all percentages for amount or amounts of ingredients used are to be understood to be percentages by weight based on the weight of the material in the total weight of the composition, wherein total is 100%.

In one aspect, the invention relates to high (50 to 90%, preferably 55 to 85% by wt.) fatty acid soap bars wherein the level of soap with K+(potassium soap) is 5% up to about 15% by wt. final bar composition. At levels above 15%, the soap mass extruded is typically too soft. For example, at higher levels, potassium soap typically becomes extremely soluble. Depending on concentration, it can be liquid, paste or shaving cream/like.

Bars of the invention have hardness of 3 to 5 Kg when measured at 40° C. using 15 millimeter penetration and cracking values of 0 to 3.

Further, final bars preferably have water level of 13 to 25%, preferably 14 to 22%, more preferably 15 to 20%, even more preferably 16 to 18% by wt. of bar.

Preferably, the bar is extruded from soaps and the soaps are formed by saponification of starting oil or oils having an average iodine value of 0 to 37, preferably 2 to 37, preferably 10 to 35. Preferably IV is 25 to 35 and more preferably 30 to 35. At higher starting IV (e.g., 30-37) oils, the amount of potassium soap formed can be in the lower part of the range (5 to 9% potassium soap) and, in lower IV oils, the amount of potassium soap formed is generally in higher range (e.g., at IV 2-10, we can typically use 10-15% potassium soap). The exact amounts of potassium soap required, within range of 5 to 15%, can vary slightly depending on composition of the oil blend. Thus, for example, as previously noted, even if the IV is the same, if the ratio of tallow oil (or equivalent palm oil or palm stearine oil) to coconut oil (or equivalent palm kernel oil) is different (weight ratio of tallow to coconut 90/10 versus weight ratio of 80/20) level of potassium soap noodles in final bar may vary slightly. Thus a 90/10 ratio may result in slightly less plastic (more rigid) soaps on saponification and may require more potassium soap to be formed to obtain a plasticity of saponified soaps which, when extruded, will produce final bars of desired hardness range compared to the amount of potassium soaps required to bring bars made from 80/20 oils into the same preferred range. The exact amount of potassium soap (e.g., within the 5 to 15% range) can be readily determined by those skilled in the art by selecting a specific amount, extruding to form final bar, and measuring hardness of final bar (using hardness value test set forth in protocol). The results of this test can be used to calibrate and determine whether the amount of potassium soap produced should be slightly raised or lowered.

In general, the term “soap” is used to mean an alkali metal or alkanol ammonium salts of aliphatic, alkane-, or alkene monocarboxylic acids derived from natural triglycerides. Sodium, potassium, magnesium, mono-, di and tri-ethanol ammonium cations, or combinations thereof, are typical counterions of the carboxylic acid. The criticality of using specific amounts of potassium soaps made, and the resulting effects on processing or properties, such as those of our invention, is not previously known. In “typical” bars used in the art, sodium soaps are generally used and, as noted, while potassium, magnesium or triethanolamine soaps are used, the particular criticalities of our invention are not known. In general, the soaps are well known alkali metal salts of natural or synthetic aliphatic (alkanoic or alkenoic) acids having about 8 to about 22 carbon atoms, preferably about 10 to about 18 carbon atoms. They may be described as alkali metal carboxylates having about 8 to about 22 carbon atoms.

Soaps having the fatty acid distribution of coconut oil may provide the lower end of the broad molecular weight range. The term coconut oil as used herein, refers to fatty acid mixtures having an approximate carbon chain length distribution of 8% 08, 7% C₁₀, 48% C₁₂, 17% C₁₄, 8% C₁₆, 2% C₁₈, 7% oleic and 2% linoleic acids (the first six fatty acids listed being saturated). Other sources having similar carbon chain length distributions, such as palm kernel oil (PKO) and babassu kernel oil, can be used in place of or together with coconut oil.

Soap having fatty acid distribution of tallow may present the upper end of the broad molecular weight range. “Tallow” oils define fatty acid mixtures which have approximate carbon chain length distribution of 2.5% C₁₄, 29% C₁₆, 23% C₁₈, 8% palmitoleic, 41.5% oleic and 3% linoleic (the first three fatty acids listed being saturated). Other oils with similar distributions can be used in place of or together with tallow. This may include oils derived from various animal tallows and lard. For purposes of this invention, this may also include oils such as palm oil (PO) or palm stearine oil (PSO).

Soaps can be classified into three broad categories which differ in the chain length of the hydrocarbon chain, i.e., the chain length of the fatty acid, and whether the fatty acid is saturated or unsaturated. For purposes of the present invention these classifications are:

“Laurics” soaps which encompass soaps which are derived predominantly from C₁₂ to C₁₄ saturated fatty acid, i.e. lauric and myristic acid, but can contain minor amounts of soaps derived from shorter chain fatty acids, e.g., C₁₀.

“Stearics” soaps which encompass soaps which are derived predominantly from C₁₆ to C₁₈ saturated fatty acid, i.e. palmitic and stearic acid but can contain minor level of saturated soaps derived from longer chain fatty acids, e.g., C₂₀.

“Oleics” soaps which encompass soaps which are derived from unsaturated fatty acids including predominantly oleic acid (C_{18:1}), linoeleic acid (C_{18:2}), myristoleic acid (C_{14:1}) and palmitoleic acid (C_{16:1}) as well as minor amounts of longer and shorter chain unsaturated and polyunsaturated fatty acids.

Coconut oil employed for the soap may be substituted in whole or in part by other “high-laurics” or “laurics rich” oils, that is, oils or fats wherein at least 45% of the total fatty acids are composed of lauric acid, myristic acid and mixtures thereof. These oils are generally exemplified by the tropical nut oils of the coconut oil class. For instance, they include: palm kernel oil, babassu oil, ouricuri oil, tucum oil, cohune nut oil, murumuru oil, jaboty kernel oil, khakan kernel oil, dika nut oil, and ucuhuba butter.

When a solid mass which includes a mixture of laurics, stearics and oleics soaps is heated, the laurics and oleics soaps, which are more water soluble and have lower melting points than stearics soaps, combine with water and other components present in the composition to form a more or less fluid liquid crystal phase depending on water content and temperature. This transformation of laurics and oleics soaps form a solid to a liquid crystal phase provides plasticity to the mass which allows it to be mixed and worked under shear, i.e. the mass is thermoplastic.

In order for typical soap bars to be extruded and stamped at high rate (at least 200 bars per minute), the IV of starting oils (making soap noodles) has typically been observed to be around 39. If IV is lower (e.g., 32), it has often been observed that the typical bar will have a hardness value above 5 Kg, a range above which ideal high throughout extrusion of soap noodles was not previously associated. At such hardness range, bars produced will typically have excessive cracking (cracking value of 4 or 5). As far as applicants are aware, the specific window of potassium soaps we have identified, and ability to reduce hardness of soaps so they process well (at high speed), while simultaneously not demonstrating excessive cracking, is not known.

As noted, level of fatty acid soap in the bar is 50% or greater, preferably 55% or greater (e.g., 65-90% by wt.).

Surfactants other than soap (commonly known as “synthetic surfactants” or “syndets”) can optionally be included in the bar at levels generally up to and including about 10%, preferably at levels between about 2% to about 7% by weight of the bar. Examples of suitable syndets are described below.

The bar may include structurants. These may include one or more polysaccharide structurants selected from the group consisting of starch, cellulose and their mixtures; one or more polyols; and optionally, a water insoluble particulate material. Structurants may, individually or combined, support 0 to 25% by wt. of bar composition.

Suitable starch materials include natural starch (from corn, wheat, rice, potato, tapioca and the like), pregelatinzed starch, physically and chemically modified starch and mixtures thereof. By the term natural starch, also known as raw or native starch, is meant starch which has not been subjected to further chemical or physical modification apart from steps associated with separation and milling.

A preferred starch is natural or native starch (commonly also known as raw starch) from maize (corn), cassava, wheat, potato, rice and other natural sources. Raw starch with different ratio of amylose and amylopectin include: maize (25% amylose); waxy maize (0%); high amylose maize (70%); potato (23%); rice (16%); sago (27%); cassava (18%); wheat (30%) and others. The raw starch can be used directly or modified during the process of making the bar composition such that the starch becomes either partially or fully gelatinized.

Another suitable starch is pre-gelatinized which is starch that has been gelatinized before it is added as an ingredient in the present bar compositions. Various forms are available that will gel at different temperatures, e.g., cold water dispersible starch. One suitable commercial pre-gelatinized starch is supplied by National Starch Co. (Brazil) under the trade name FARMAL CS 3400 but other commercially available materials having similar characteristics are suitable.

Suitable cellulose materials include microcrystalline cellulose, hydroxyalkyl alkylcellulose ether and mixture thereof.

A preferred cellulose material is microcrystalline cellulose (a highly crystalline particulate cellulose made primarily of crystalline aggregates) which is obtained by removing amorphous fibrous cellulose regions of a purified cellulose source material by hydrolytic degradation. This is typically done with a strong mineral acid (e.g., hydrogen chloride). The acid hydrolysis process produces microcrystalline cellulose of predominantly coarse particulate aggregates, typically of mean size range 10 to 40 microns. One suitable commercial microcrystalline cellulose is supplied by FMC Biopolymer (Brazil) under the trade name AVICEL GP 1030 but other commercially available materials having similar characteristics are suitable.

A preferred polysaccharide structurant is starch, most preferably a natural starch (raw starch), a pre-gelatinized starch, a chemically modified starch or mixtures thereof. Raw starch is preferred.

Polyol is a term used herein to designate a compound having multiple hydroxyl groups (at least two, preferably at least three) which is highly water soluble, preferably freely soluble, in water.

Many types of polyols are available including: relatively low molecular weight short chain polyhydroxy compounds such as glycerol and propylene glycol; sugars such as sorbitol, manitol, sucrose and glucose; modified carbohydrates such as hydrolyzed starch, dextrin and maltodextrin, and polymeric synthetic polyols such as polyalkylene glycols, for example polyoxyethylene glycol (PEG) and polyoxypropylene glycol (PPG).

Preferred polyols are relatively low molecular weight compound which are either liquid or readily form stable highly concentrated aqueous solutions, e.g., greater that 50% and preferably 70% or greater by weight in water. These include low molecular weight polyols and sugars.

Especially preferred polyols are glycerol, sorbitol and their mixtures.

Preferred inorganic particulate material includes talc and calcium carbonate. Talc is a magnesium silicate mineral material, with a sheet silicate structure represented by the chemical formula Mg₃Si₄ (O)_{1O}(OH)₂, and may be available in the hydrated form. Talc has a plate-like morphology, and is substantially oleophilic/hydrophobic.

Calcium carbonate or chalk exists in three crystal forms: calcite, aragonite and vaterite. The natural morphology of calcite is rhombohedral or cuboidal, acicular or dendritic for aragonite and spheroidal for vaterite.

Commercially, calcium carbonate or chalk (precipitated calcium carbonate) is produced by a carbonation method in which carbon dioxide gas is bubbled through an aqueous suspension of calcium hydroxide. In this process the crystal type of calcium carbonate is calcite or a mixture of calcite and aragonite.

Examples of other optional insoluble inorganic particulate materials include alumino silicates, aluminates, silicates, phosphates, insoluble sulfates, borates and clays (e.g., kaolin, china clay) and their combinations.

Organic particulate materials include: insoluble polysaccharides such as highly cross-linked or insolubilized starch (e.g., by reaction with a hydrophobe such as octyl succinate); synthetic or natural polymers such as various polymer lattices and suspension polymers and mixtures thereof.

The bars may comprise anti-cracking agents such as carboxymethylcellulose, acrylate polymers and their mixtures.

The bars comprise water at level of 10 to 25% by wt. Lower level of water may be 11 or 12 or 13% and upper level may be 24 or 22%.

In terms of possible optional ingredients, various additional electrolytes (in addition to the fatty acid soap and other charged surfactants which are electrolyte), especially those having alkali metal cations can be present in the bar. These electrolytes are present either as a result of saponification and neutralization of the fatty acids, e.g., NaCl generated from saponification with sodium hydroxide and neutralization with hydrochloric acid, or as added salts such as sodium or potassium sulfate which may be used to control hardness. Various electrolytes can be used in modest amounts as long as they are not strong detergent builders or otherwise interfere with the efficacy of the anti-cracking agents.

The level of electrolytes should be less than 2.0%, preferably less than 1.5%, preferably up to about 1.0%, preferably up to and including 0.8%, e.g., 0.1 to 0.8%. No extra electrolyte, other than sodium chloride (NaCl), is necessary for the formulation space in this case. In at least one form, no electrolyte, other than NaCl, is present in compositions of the invention.

The bar compositions can optionally include non-soap synthetic type surfactants (detergents)—so called “syndets”. Syndets can include anionic surfactants, nonionic surfactants, amphoteric or zwitterionic surfactants and cationic surfactants.

The level of synthetic surfactant, individually or combined, present in the bar is generally not greater than about 10% in the continuous phase although inclusion of higher levels in the bar may be advantageous for some applications. Some embodiment of the invention includes syndets at a level of about 2% to 10%, preferably about 4% to about 10%.

The term “slip modifier” is used herein to designate materials that when present at relatively low levels (generally less than 1.5% based on the total weight of the bar composition) will significantly reduce the perceived friction between the wet bar and the skin. The most suitable slip modifiers are useful, individually or combined, at a level of 1% or less, preferably from 0.05 to 1% and more preferably from 0.05% to 0.5%.

Slip modifiers are particularly useful in bar compositions which contain starch/cellulose and/or insoluble particles whose levels approach the higher end of the useful concentration range for these materials, e.g., 30-40% for starch with 5-10% insoluble particulate material. It has been found that the incorporation of higher levels of starch and/or insoluble particles increases the wet skin friction of the bar and the bars are perceived as “draggy” (have a high perceived level of frictional “drag” on the skin). Although some consumers do not mind this sensory quality, while others dislike the sensation. In general, consumers prefer bars that are 20 perceived to glide easily over their skin and are perceived as being slippery.

It has been found that certain hydrophobic materials incorporated at low levels can dramatically reduce the wet skin frictional drag of bars containing higher levels of starch and/or insoluble particles to improve consumer acceptability.

Suitable slip modifier include petrolatum, waxes, lanolines, poly-alkane, -alkene, -polyalkalyene oxides, high molecular weight polyethylene oxide resins, silicones, polyethylene glycols and mixtures thereof.

Particularly suitable slip modifiers are high molecular weight polyethylene oxide homopolymer resins having molecular weights of from about 100,000 to about 7,000,000. The polymers have a degree of polymerization from about 2,000 to about 100,000. These polymers are available as white powders.

Preferably the molecular weight of the polyethylene oxide resin is greater than 80,000, more preferably at least 100,000 Daltons and most preferably at least 400,000 Daltons. Examples of suitable high molecular weight polyethylene oxide resins are water soluble resins supplied by Dow Chemical Company under the trade name POL VOX. An example is WSR N-301 (molecular weight 4,000,000 Daltons).

Adjuvants are ingredients that improve the aesthetic qualities of the bar especially the visual, tactile and olefactory properties either directly (perfume) or indirectly (preservatives). A wide variety of optional ingredients can be incorporated in bars of the current invention. Examples of adjuvants include but are not limited to: perfumes; opacifying agents such as fatty alcohols, ethoxylated fatty acids, solid esters, and Ti02; dyes and pigments; pearlizing agent such as Ti02 coated micas and other interference pigments; plate like mirror particles such as organic glitters; sensates such as menthol and ginger; preservatives such as dimethyloldimethylhydantoin (Glydant XL 1000), parabens, sorbic acid and the like; anti-oxidants such as, for example, butylated hydroxy toluene (BHT); chelating agents such as salts of ethylene diamine tetra acetic acid (EDTA) and trisodium etridronate (provided it is present at less than about 0.3%); emulsion stabilizers; auxiliary thickeners; buffering agents; and mixtures thereof.

The level of pearlizing agent, if present, should be between about 0.1% to about 3%, preferably between 0.1% and 0.5% and most preferably between about 0.2 to about 0.4% based on the total weight of the composition.

Adjuvants are commonly collectively designated as “minors” in the soap making art and frequently include at a minimum, colorant (dyes and pigments), perfume, preservatives and residual salts and oils from the soap making process, and various emotive ingredients such as witch-hazel. Minors generally constitute 4 to 10% by weight of the total continuous phase composition, preferably 4 to 8%, and often about 5-7% of the continuous phase.

Free fatty acids (FFA) up to 3% such as coconut fatty acid, PKO fatty acid, lauric acid are commonly used in soap bars for overall quality and process improvement. Free fatty acid higher than 3% will lead to soft and sticky mass and will negatively impact in bar quality. In at least one form, level of FFA in compositions of the invention is 0.05 to 3%, preferably 0.1 to 2%, more preferably 0.1 to 1.5% by wt.

A particular class of optional ingredients highlighted here is skin benefit agents included to promote skin and hair health and condition. Potential benefit agents include but are not limited to: lipids such as cholesterol, ceramides, and pseudoceramides; antimicrobial agents such as TRICLOSAN; sunscreens such as cinnamates; exfoliant particles such as polyethylene beads, walnut shells, apricot seeds, flower petals and seeds, and inorganics such as silica, and pumice; additional emollients (skin softening agents) such as long chain alcohols and waxes like lanolin; additional moisturizers; skin-toning agents; skin nutrients such as vitamins like Vitamin C, D and E and essential oils like bergamot, citrus unshiu, calamus, and the like; water soluble or insoluble extracts of avocado, grape, grape seed, myrrh, cucumber, watercress, calendula, elder flower, geranium, linden blossom, amaranth, seaweed, gingko, Ginseng, carrot; Impatiens balsamina, camu camu, Alpina leaf and other plant extracts such as witch-hazel, and mixtures thereof.

The composition can also include a variety of other active ingredients that provide additional skin (including scalp) benefits. Examples include anti-acne agents such as salicylic and resorcinol; sulfur-containing 0 and L amino acids and their derivatives and salts, particularly their N-acetyl derivatives; anti-wrinkle, anti-skin atrophy and skin-repair actives such as vitamins (e.g., A, E and K), vitamin alkyl esters, minerals, magnesium, calcium, copper, zinc and other metallic components; retinoic acid and esters and derivatives such as retinal and retinol, vitamin B3 compounds, alpha hydroxy acids, beta hydroxy acids, e.g. salicylic acid and derivatives thereof; skin soothing agents such as aloe vera, jojoba oil, propionic and acetic acid derivatives, fenamic acid derivatives; artificial tanning agents such as dihydroxyacetone; tyrosine; tyrosine esters such as ethyl tyrosinate and glucose tyrosinate; skin lightening agents such as aloe extract and niacinamide, alpha-glyceryl-L-ascorbic acid, aminotyroxine, ammonium lactate, glycolic acid, hydroquinone, 4 hydroxyanisole, sebum stimulation agents such as bryonolic acid, dehydroepiandrosterone (DHEA) and orizano; sebum inhibitors such as aluminum hydroxy chloride, corticosteroids, dehydroacetic acid and its salts, dichlorophenyl imidazoldioxolan (available from Elubiol); anti-oxidant effects, protease inhibition; skin tightening agents such as terpolymers of vinylpyrrolidone, (meth)acrylic acid and a hydrophobic monomer comprised of long chain alkyl (meth)acrylates; anti-itch agents such as hydrocortisone, methdilizine and trimeprazine hair growth inhibition; 5-alpha reductase inhibitors; agents that enhance desquamation; anti-glycation agents; anti-dandruff agents such as zinc pyridinethione; hair growth promoters such as finasteride, minoxidil, vitamin D analogues and retinoic acid and mixtures thereof.

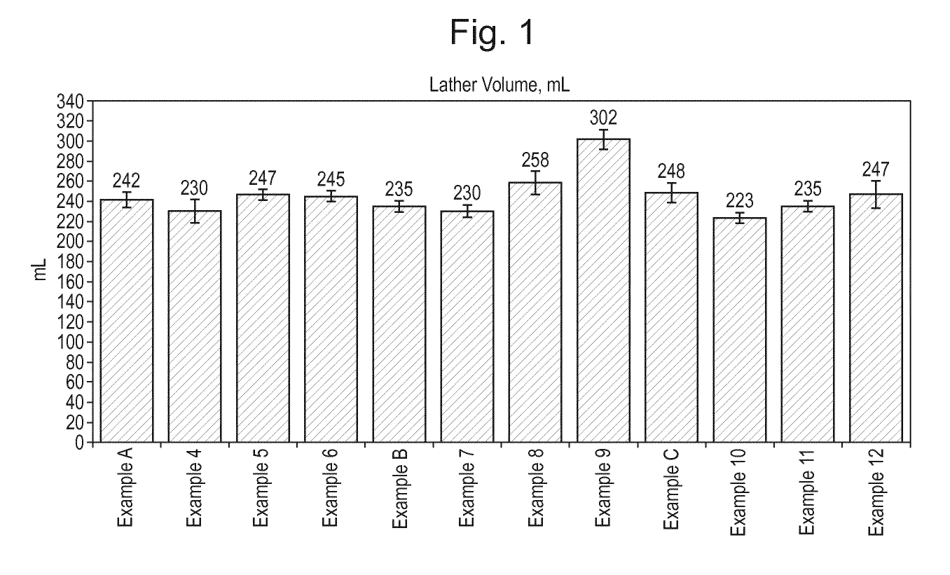

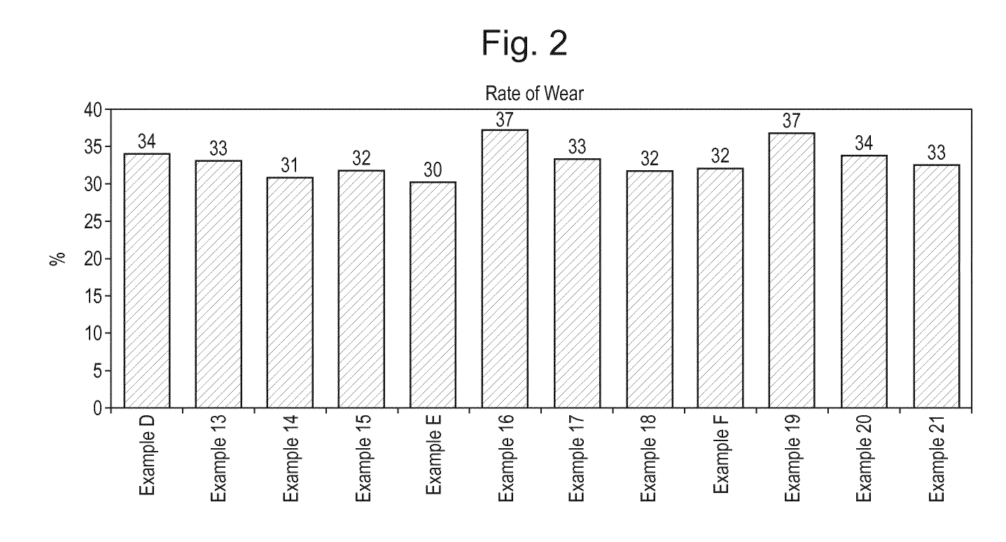

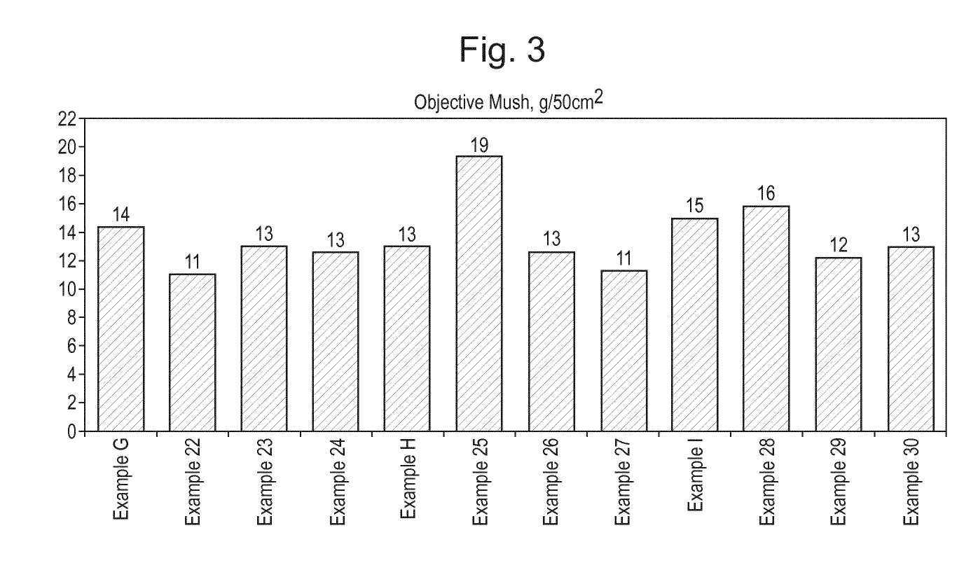

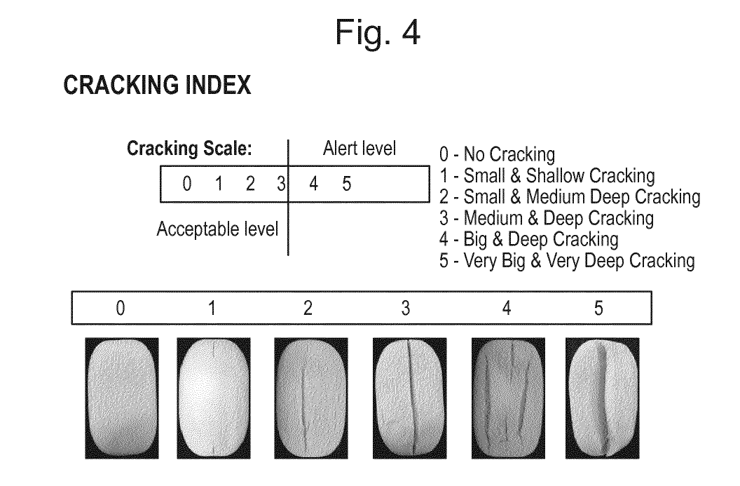

Regardless of the optional agent or agents employed, their level should be chosen such that the composition is an extrudable mass (penetrometer hardness of 3 to 5 Kg kPa measured at a temperature of 40° C.; preferably bars should have yield stress of 350 to 2000 kPa) and the bars derived from the composition conveniently have a Cracking Index of 3 or less. Cracking Index is based on a scale in which the degree of cracking can be visually observed (see FIG. 4) as described in the protocol. The yield stress referred to is the static yield stress. It is equivalent to extensional stress and is calculated, as set forth in the protocol section below, also using penetrometer device.

As mentioned, when starting oils are saponified, it is critical that 5 to 15% potassium soap be formed. The exact amount, within this range, is readily ascertainable by calibrating using the hardness value test. By ensuring correct window of production of potassium soap noodles (and more specifically, the correct range or amount within this window and which can be readily determined by those skilled in the art), this unexpectedly permits use of starting oil or oils having iodine value of 0 to 37, lower than would have been thought required in order to obtain bars having preferred hardness values as defined and without excessive cracking; further this is accomplished while retaining user benefits associated with the lower IV oils used. In addition, using lower IV oils we obtain lather comparable to use of high IV oils as well as unexpected enhancement in perfume performance. It is noted that a single and (rather than blend) can be theoretically used but blends are preferred. Also, oil of IV zero, for example, is not believed to exist in nature but distilled fractions can be prepared to obtain desired IV values.

The benefit agent bars of the invention further preferably comprise essential oils.

Essential oil is intended to encompass natural or synthetic fragrances, including natural oil synthetic perfumes. It may be a substance selected from perfume, terpene, terpenoid, various other essential oils (which may include antimicrobial essential oil or an active thereof, or a mixture thereof), or a synthetic compound having odoriferous properties, especially selected from aldehydes, esters, ketones, ionones, ethers and alcohols. If a perfuming substance, it can be a complex perfume composition containing a mixture of various terpenes, terpenoids, essential oils, synthetic odoriferous or more pure compounds. In solution, the weight percentage of said perfuming composition or substance may be between 1% to 10%, and especially from 3% to 10%, and being in particular approximately equal to 5% or approximately equal to 10% (wt. % of total bar).

“Odoriferous” means a detectable substance olfactively by a subject and/or by olfactormetry according to known principles of art. An exemplary method for the detection of an odoriferous substance is described in EP 0003088. Other detection techniques of an odoriferous substance are applicable as the chromatography techniques in a gas phase spectroscopy of Niasse or yet infrared absorption analysis.

By “terpenes” is meant hydrocarbons wherein the base member is isoprene, their molecular formula comprising a multiple number of carbons 5, particularly terpenes particularly containing 10 to 15 carbon atoms, used in perfumery.

By “terpenoid” means derivatives of terpenes, for example, alcohols, phenols, ketones, aldehydes, esters, ethers.

The following list of odoriferous compounds provided for illustrative purposes, is by no means exhaustive:

terpenes pirene, camphene, limonene, cadinene, hull, caryophyliene,

alcohols: linolool, geraniol, menthol, citronellol, ketones, menthione, carvone, beta-ionone, thujone, camphor, cyclopertadecanone

aldehyde: citral, citrannal, citronellal, cinnamic alkehyde, lilial,

esters: linalyl acetate, methyl acetate, getranyl acetate, geranyl succinates, phenols, thymol, carvacrol, eugenol, isoeugenol,

ethers: anthole, eucalyptol, cineol, rose oxide.

Essential oils can be oils of yiang-yiang, bergamot, Eucalyptus, lavender, lavender, lemongrass, patchouli, peppermint, pine, rose, coriander, Shiu, of sage, geranium, palmarosa, Litsea cubeba, lemon, lemongrass, orange blossom, grapefruit, lime, mandarin, tangerine, orange, cajeput, camphor, rosemary, d anise, star anise, fennel, basil, tarragon, clove, pepper, thyme, sassafras, wormwood, mugwort, cedar, hyssop. Tagetes of street, elemi, Galbanum, juniper berries, cabreuva, guaiac wood, sandalwood, vetiver, ambrette, Angelica, orris rhizome, carrot, celery, cumin, lovage, parsley, cinnamon, cardamom, ginger, nutmeg, pepper, frankincense, myrrh, balsam of Peru, Styrax, buchu, chamomile or cistus (Jean Garnero, “Essential oils” engineering techniques, physic-chemical constants Treaty, K-345).

Typical perfumery material which may form part of, or possibly the whole of, the active ingredient include natural essential oils such as lemon oil, mandarin oil, clove leaf oil, petitgrain oil, cedar wood oil, patchouli oil, lavandin oil, neroli oil, ylang oil, rose absolute or jasmine absolute, natural resins such as labdalium resin or olibanun resin; single perfumery chemicals which may be isolated from natural sources or manufactured synthetically, as for example alcohols such as geraniol, nerol, citronellol, linalool, tetrahydro-geraniol, betaphenylethyl alcohol, methyl phenyl carbinol, dimethyl benzyl carbinol, -menthol or cedrol; acetates and other esters derived from such alcohols; aldehydes such as citral, citronellal, -hydroxy-citronellal, lauric aldehyde, undecylenic-aldehyde, cinnamaldehyde, amyl cinnamic aldeyde, vanillin or heliotropin; acetals derived from such aldehydes; ketones such as methyl hexyl ketone, the ionones and the methylionones; phenolic compounds such as eugenol and isoeu-genol; synthetic musks such as musk xylene, musk ketone and ethylene brassylate; and other materials commonly employed in the art of perfumery. Typically at least five, and usually at least ten, of such materials will be present as components of the active ingredient.

Besides fragrance material, volatile insecticides, bacteriocides, pheronones and fabric softeners can also usefully be incorporated.

As noted, antimicrobial essential oils and actives thereof, or mixture may be used.

Such antimicrobial essential oils include, but are not limited to, those obtained from thyme, lemongrass, citrus, lemons, orange, anise, clove, aniseed, pine, cinnamon, geranium, roses, mint, lavender, citronella, Eucalyptus, peppermint, camphor, ajowan, sandalwood, rosmarin, vervain, fleagrass, lemongrass, ratanhiae, cedar and mixtures thereof. Preferred antimicrobial essential oils to be used herein are thyme oil, clove oil, cinnamon oil, geranium oil, Eucalyptus oil, peppermint oil, citronella oil, ajowan oil, mint oil or mixtures thereof.

Actives of essential oils which may be used herein include, but are not limited to, thymol (present for example in thyme, ajowan), eugenol (present for example in cinnamon and clove), menthol (present for example in mint), geraniol (present for example in geranium and rose, citronella), verbenone (present for example in vervain), eucalyptol and pinocarvone (present in Eucalyptus), cedrol (present for example in cedar), anethol (present for example in anise), carvacrol, hinokitiol, berberine, ferulic acid, cinnamic acid, methyl salicylic acid, methyl salycilate, terpineol, limonene and mixtures thereof. Preferred actives of essential oils to be used herein are thymol, eugenol, verbenone, eucalyptol, terpineol, cinnamic acid, methyl salicylic acid, limonene, geraniol or mixtures thereof.

Thymol may be commercially available for example from Aldrich—Manheimer Inc, eugenol may be commercially available for example from Sigma, Systems—Bioindustries (S81)—Manheimer Inc.

Preferably, the antimicrobial essential oil or active thereof or mixture thereof is present in the composition at a level up to 20% by weight of the total composition, preferably at a level of at least 0.003% to 10%, more preferably from 0.006% to 10%, even more preferably from 0.01% to 8% and most preferably from 0.03% to 3%.

The soap bars which comprise essential oils have compositions such as those noted in the first aspect of the invention.

The bars of the invention, made from oils having IV 0-37 saponified to form 5 to 15% potassium soaps (in turn extruded to form the final bars), provide unexpected enhancement in headspace over the bar or over diluted bar relative to bar made in which starting oil has higher IV (for example 39) and no potassium soap is formed.

### Protocol

### 1) Hardness

### Hardness Testing Protocol

### Principle

A 30° conical probe penetrates into a soap/syndet sample at a specified speed to a pre-determined depth. The resistance generated at the specific depth is recorded. There is no size or weight requirement of the tested sample except that the bar/billet be bigger than the penetration of the cone (15 mm) and have enough area. The recorded resistance number is also related to the yield stress and the stress can be calculated as noted below. The hardness (and/or calculated yield stress) can be measured by a variety of different penetrometer methods. In this invention, as noted above, we use probe which penetrates to depth of 15 mm.

### Apparatus and Equipment

TA-XT Express (Stable Micro Systems)

30° conical probe—Part #P/30c (Stable Micro Systems)

### Sampling Technique

This test can be applied to billets from a plodder, finished bars, or small pieces of soap/syndet (noodles, pellets, or bits). In the case of billets, pieces of a suitable size (9 cm) for the TA-XT can be cut out from a larger sample. In the case of pellets or bits which are too small to be mounted in the TA-XT, the compression fixture is used to form several noodles into a single pastille large enough to be tested.

### Procedure

### Setting Up the TA-XT Express

These settings need to be inserted in the system only once. They are saved and loaded whenever the instrument is turned on again. This ensures settings are constant and that all experimental results are readily reproducible.

### Set Test Method

Press MENU

Select TEST SETTINGS (Press 1)

Select TEST TPE (Press 1)

Choose option 1 (CYCLE TEST) and press OK

Press MENU

Select TEST SETTINGS (Press 1)

Select PARAMETERS (Press 2)

Select PRE TEST SPEED (Press 1)

Type 2 (mm s⁻¹) and press OK

Select TRIGGER FORCE (Press 2)

Type 5 (g) and Press OK

Select TEST SPEED (Press 3)

Type 1 (mm s⁻¹) and press OK

Select RETURN SPEED (Press 4)

Type 10 (mm s⁻¹) and press OK

Select DISTANCE (Press 5)

Type 15 (mm) for soap billets or 3 (mm) for soap pastilles and press OK

Select TIME (Press 6)

Type 1 (CYCLE)

### Calibration

Screw the probe onto the probe carrier.

Press MENU

Select OPTIONS (Press 3)

Select CALIBRATE FORCE (Press 1)—the instrument asks for the user to check whether the calibration platform is clear

Press OK to continue and wait until the instrument is ready.

Place the 2 kg calibration weight onto the calibration platform and press OK

Wait until the message “calibration completed” is displayed and remove the weight from the platform.

### Sample Measurements

Place the cut billet after the extrusion (maximum 30 min) onto the test platform.

Place the probe close to the surface of the billet (without touching it) by pressing the UP or DOWN arrows.

### Press RUN

Take the readings (g or kg) at the target distance (Fin).

After the run is performed, the probe returns to its original position.

Remove the sample from the platform and record its temperature.

### Calculation & Expression of Results

### Output

The output from this test is the readout of the TA-XT as “force” (R_{T}) in g or kg at the target penetration distance, combined with the sample temperature measurement. (In the subject invention, the force is measured in Kg at 40° C. at 15 mm distance)

The force reading can be converted to extensional stress, according to Equation 2.

The equation to convert the TX-XT readout to extensional stress is

$$σ = \frac{1}{C} \frac{{R}_{T} {g}_{c}}{A}$$

where: σ=extensional stress
   C=“constraint factor” (1.5 for 30° cone)
   G_{c}=acceleration of gravity
   A=projected area of cone=π(d tan ½ θ)²
   d=penetration depth
   θ=cone angle

For a 30° cone at 15 mm penetration Equation 2 becomes

σ(Pa)=R_{T} (g)×128.8

This stress is equivalent to the static yield stress as measured by penetrometer.

The extension rate is

$$\dot{ɛ} = \frac{V}{d tan ( \frac{1}{2} θ )}$$

where \acute{ε}=extension rate (s⁻¹)
   V=cone velocity
For a 30° cone moving at 1 mm/s, \acute{ε}=0.249 s⁻¹

### Temperature Correction

The hardness (yield stress) of skin cleansing bar formulations is temperature-sensitive. For meaningful comparisons, the reading at the target distance (R_{T}) should be corrected to a standard reference temperature (normally 40° C.), according to the following equation:

R₄₀=R_{T}×exp[α(T−40)]
where R₄₀=reading at the reference temperature (40° C.)
   R_{T}=reading at the temperature T
   α=coefficient for temperature correction
   T=temperature at which the sample was analyzed.

The correction can be applied to the extensional stress.

### Raw and Processed Data

The final result is the temperature-corrected force or stress, but it is advisable to record the instrument reading and the sample temperature also.

2) Lather volume (FIG. 1)

### Definitions

Lather volume is related to the amount of air that a given soap bar composition is capable of trapping when submitted to standard conditions.

### Principle:

Lather is generated by trained technicians using a standardized method. The lather is collected and its volume measured.

### Apparatus and Equipment:

Washing up bowl—1 per operator capacity 10 liters

Soap drainer dishes—1 per sample

Surgeons' rubber gloves—British Standard BS 4005 or equivalent (see Note 14ii).

Range of sizes to fit all technicians

Tall cylindrical glass beaker—400 mL, 25 mL graduated (Pyrex n° 1000)

Thermometer—Mercury types are not approved

Glass rod—Sufficiently long to allow stirring in the glass beaker

### Procedure:

### Tablet Pre-Treatment:

Wearing the specified type of glove well washed in plain soap, wash down all test tablets at least 10 minutes before starting the test sequence. This is best done by twisting them about 20 times through 180° under running water.

Place about 5 liters of water at 30° C. of known hardness (hardness should be constant through a series of tests) in a bowl. Hardness can be measured, for example, in units of French degrees (° fH or ° f), which may also be defined as 10 mg/Liter of CaCO₃, equivalent to 10 parts per million (ppm). Hardness may typically range from 5 to 60° fH. Tests of the subject invention were conducted at 18° fH. Change the water after each bar of soap has been tested.

Take up the tablet, dip it in the water and remove it. Twist the tablet 15 times, between the hands, through 180°. Place the tablet on the soap dish (see Note).

The lather is generated by the soap remaining on the gloves.

Stage 1: Rub one hand over the other hand (two hands on same direction) 10 times in the same way (see Note).

Stage 2: Grip the right hand with the left, or vice versa, and force the lather to the tips of the fingers.

This operation is repeated five times.

Repeat Stages 1 and 2

Place the lather in the beaker.

Repeat the whole procedure of lather generation from paragraph iii, twice more, combining all the lather in the beaker.

Stir the combined lather gently to release large pockets of air. Read and record the volume.

### Calculation & Expression of Results:

The data obtained consists of six results for each bar under test.

Data analysis is carried out by two way analysis of variance, followed by Turkey's Test.

### Operators:

Experienced technicians should be able to repeat lather volumes to better than ±10%. It is recommended that technicians be trained until they are capable of achieving reproducible results from a range of different formulation types.

### Notes:

Water hardness, as noted above, should be constant for a series of tests and should be recorded. Where possible, it is preferable to adhere to suitable water hardness. For example, bars which will be used in soft water markets should ideally be tested with soft water (e.g., lower end of French hardness scale).

It is important to keep the number of rubs/twists constant.

### 3) Wear (FIG. 2) and Cracking (FIG. 4)

### Definitions

The rate of wear (RoW) relates to the amount of material which is lost by a soap bar product under controlled conditions. These conditions for use, mimic approximately the way consumers use the product.

Cracking can be defined as the physical damage which may result (or not) from the sequence of washdown and drying of the bar, as per the protocol bellow.

### Principle:

Soap tablets are washed down in a controlled manner, 6 times per day for 4 days. The tablets are stored in controlled conditions after each washdown, and the weight loss is determined after a further 2 or 3 days drying out.

Visual cracking assessments is made after 3 days of drying out under ambient conditions.

### Apparatus and Equipment:

| | |
|---|---|
| Soap trays, with drainers | preferably rigid plastic |
| | 1 sample per condition |
| Soap trays, without drainers | preferably rigid plastic |
| | area of approximately 15 × 10 cm |
| | flat bottom |
| | 1 sample per batch |
| Washing bowl | 10 liter capacity (approx.) |
| Gloves | waterproof, disposable gloves |
| | (plastic or rubber) |

### Procedure:

Start the test on first morning (e.g., a Monday).

Weigh 4 tablets of each of the batches to be tested and put them on soap trays that have been coded as follows:

| Drainers? | Wash temperature (° C.) |
|---|---|
| Yes | 25 |
| Yes | 40 |
| No | 25 |
| No | 40 |

Measure 10 mL of water (room temperature and appropriate hardness) and pour into the tray without drainers (25° and 40° C.).

Carry out washdowns on each tablet of soap as follows:

(a) Fill washing bowl with about 5 liters of water with appropriate hardness, and at the desired temperature (25° C. or 40° C.).

(b) Mark the tablet to identify top face (e.g. make small hole with a needle).

(c) Wearing waterproof gloves, immerse the tablet in the water, and twist 15 times (180° each time) in the hands above water.

(d) Repeat (c).

(e) Immerse the tablet in the water again in order to wash off the lather.

(f) Place the tablet back on its soap tray, ensuring that the opposite face is uppermost (i.e. the unmarked face).

Carry out the full washdown procedure 6 times per day for 4 consecutive days, at evenly spaced intervals during each day (e.g. hours in day: 8.00, 09:30, 11.00, 12.30, 14.00, and 15.30. Alternate the face placed down after each washdown.

Between washdowns the soap trays should be left on an open bench or draining board, at controlled room conditions. (See Note 14.1.iii) After each washdown cycle, change the position of each soap tray/tablet on the bench, to minimize variability in drying conditions. At the end of each day:
rinse and dry each soap tray with drainer
drain and refill the soap tray without drainer (25° C. and 40° C.) with 10 mL water (ambient temperature). Consider the appropriate water hardness.

After the last wash down (afternoon of fourth day, e.g., Thursday), rinse and dry all soap trays, and place each tablet on its soap tray.

On 5th day afternoon, turn the samples so they can dry both sides.

On the eighth day (e.g., following Monday), weigh each tablet

### Cracking:

The visual assessment of the degree of cracking is carried out with the same samples used in the rate of wear test. Some cracking may occur during the first 5 days of the test, but for maximum level can be only observed after the final length of the test (i.e. on the 8th or 9th day).

### Calculation & Expression of Results:

### Rate of Wear:

Rate of wear is defined as the weight loss in grams or percentage. One shall bare in mind that the results are relative to the test conditions.

$$Wear ( \% ) = \frac{( initial weight - final weight ) * 100}{Initial weight}$$

$$Wear ( g ) = ( initial weight - final weight )$$

A team of expert technicians must be able to attain less than 10% differences between duplicates.

### Cracking

A trained assessor examines the tablets and records separately the degree of cracking in each of the following areas:

| | |
|---|---|
| Both faces | all types of tablets |
| Both ends | band-type tablets |
| Both sides | band-type tablets |
| Periphery | capacity die tablets |

The degree of cracking is graded using the following 0-5 scale:

0—No cracking

1—Small and shallow cracking:
1.1—minimum degree
1.2—maximum degree

2—Small and medium deep cracking:
2.1—minimum degree
2.2—maximum degree

3—Medium and deep cracking:
3.1—minimum degree
3.2—maximum degree

4—Big and deep cracking:
4.1—minimum degree
4.2—maximum degree

5—Very big and very deep cracking:
5.1—minimum degree
5.2—maximum degree

4) Objective Mush (FIG. 3)

### Definitions

Mush is defined as the jelly, creamy material that forms when toilet soap bars absorbs water.

The Mush Immersion Test described here gives a numerical value for the amount of mush formed on a bar. The Mush by Immersion value does not distinguish between different types of mush; these aspects are assessed by the “Subjective Mush Test”.

### Principle:

Soap tablets are cut down to give a rectangular block, which is immersed in demineralized water at 20° C. for 2 hours. The soap mush formed is scraped off and its weight determined.

### Apparatus and Equipment:

| | |
|---|---|
| 250-ml beakers | 1 per sample |
| Sample holders | 1 per sample |
| Water bath | Thermostatically controlled at |
| | 20° C. + −0.5° C. |
| | Large enough to accommodate all beakers |
| Tablet cutter size | plane, knife or cutting jig designed to |
| | cut samples to predetermined |
| Scraper | preferably plastic (e.g. laboratory spatula) |
| | must have a straight corner |

### Procedure:

Cut a rectangular billet from the soap tablet to the required dimensions using a plane, knife or cutting jig.

Measure the width and depth of the cut billet accurately (±0.1 cm).

Measure 5 cm from the bottom of the billet, and draw a line across the billet at this point. This is the immersion depth.

Attach the billet to the sample holder and suspend the billet in an empty beaker.

Add demineralized (or distilled) water at 20° C. to the beaker until the level reaches the 5 cm mark on the billet.

Place the beaker in a water bath at 20° C. (±0.5° C.) and leave for exactly 2 hours.

Remove the soap-holder+billet, empty the water from the beaker, and replace the soap-holder+billet on the beaker for 1 minute so that excess water can drain off.

Shake off extraneous water, remove the billet from the soap-holder, and weigh the billet (WM), standing it on its dry end.

Carefully scrape off all the mush from all 5 faces of the billet, and remove any remaining traces of mush by wiping gently with a tissue.

Weigh the billet within 5 minutes of scraping (WR).

### Calculation & Expression of Results:

Weight of mush (grams)

Surface area (cm²)=A=10 (width+thickness)+(width×thickness)

NB—this equation presumes 5 cm immersion

$$Mush ( g \text{/} 50 {cm}^{2} ) = \frac{( {W}_{M} - {W}_{R} ) \cdot 50}{A}$$

$$Lost mass ( g \text{/} 50 {cm}^{2} ) = \frac{( {W}_{O} - {W}_{R} ) \cdot 50}{A}$$

$$Absorbed water ( g \text{/} 50 {cm}^{2} ) = \frac{( {W}_{M} - {W}_{O} ) \cdot 50}{A}$$

initial weight (Wo)
weight after mushing (WM)
weight after removing mush (WR)

5) Head Space

Fragrance performance was measured by evaluating three key fragrance attributes.

The first attribute is the concentration of fragrance in the static headspace above a neat sample—solid soap. This measurement evaluates the amount of fragrance that a consumer smells when they sniff the bar. It is referred to as the initial impact assessment. The soap bar was shaved to half of the total bar volume from one side, and the shaved bar flakes were mixed well before 2 grams were weighed into a 20 ml GC (gas chromatography) vial to ensure an even sampling of the outer and inner portion of the bar. The air above soap is allowed to come to equilibrium with the soap sample by leaving the sealed GC vial in room temperature for at least 24 hours. After equilibrium is achieved, the relative fragrance concentration in the air of the GC vial is measured by GC/MS (gas chromatography/mass spectrometer). Samples are made in triplicates.

The second attribute measured is the amount of fragrance in the static headspace above a diluted soap slurry. The fragrance concentration above the 30 times diluted soap correlates well with the fragrance intensity that a consumer experiences during a shower (blooming) when using the bar. For this measurement, soap was diluted 30 times with water. Again, 2 gram of the diluted soap is sealed in a 20 ml GC vial. The air above the diluted body wash is allowed to come to equilibrium with the soap dilution by leaving the sealed GC vial in room temperature for at least 24 hours. After equilibrium is achieved, the relative fragrance concentration in the air of the GC vial is measured by GC/MS (gas chromatography/Mass spec). Triplicate GC samples were made and measured for each diluted sample.

For measurement of both attributes, GC (e.g., column used was HP-5MS model number: Agilent 19091S-433) conditions were as follows: Injector was in splitless mode using helium as carrier gas. Injection port was heated to about 250 degrees centigrade, Pressure 12.01 psi, purge flow 8.1 mL/min at 1.0 minute, total flow 17.1 mL/min. Column was in constant flow mode with 1.3 ml/min flow rate. Oven temperature ramp: hold at 70 degrees centigrade for 2 minutes, then increase oven temperature at a rate of 3 degrees centigrade/min to 125 degrees centigrade, 15 degrees centigrade/min to 280 degrees centigrade and hold for 2 minutes. Fragrance samples were run in scan mode with mass range set at 35-300 amu. Hygiene actives were run using SIM mode targeting ions having m/z 59, 135, and 136. Autosampler's conditions were: No incubation (all experiments done in room temperature). SPME (solid phase micro-extraction) fiber was inserted into the sample headspace for a 5 minute extraction and then injected to the injector for a 15 minute desorption.

The third attribute is the amount of fragrance deposited on Vitroskin washed with soap. A 3 cm×6 cm piece of Vitro Skin (N19 IMS inc.) is washed with 0.5 g of sample. Water temp is controlled at 95F and flow rate is controlled at 3-4 L/min. A watch glass (or other rigid, nonabsorbent, non porous substrate) is used as a base for washing the Vitro skin. The Vitroskin is held on the watch glass with the thumb rough side up. The Vitroskin is rinsed for 30 seconds prior to treatment and excess water is poured off of the Vitroskin. 0.5 g of sample is dosed onto wet skin, lathered with forefinger for 30 seconds (out of the stream of water), and rinsed for 15 seconds (making sure to rinse both sides of the Vitroskin in case any sample was trapped under the Vitroskin). Treated Vitroskin was then patted dry between the layers of a folded paper towel for 10 pats (hand held palm facing down so that both surfaces of the Vitroskin are dried), Samples were placed into GC vial immediately and allowed to equilibrate for 24 hours at room temperature. The Vitroskin can be rolled carefully with tweezers, using a forefinger to keep the Vitroskin from unrolling. The tighter the Vitroskin is rolled the easier it is to place in the vial. The vial is allowed to equilibrate for 24-48 hours. Additionally, an incubation step is included prior to SPME to increase volatiles in the headspace. The samples are incubated for 25 minutes at 45 C, then sampled as described in the previous method depending on the actives delivered.

### Examples 1-3

In order to demonstrate the effect of potassium soap on high throughput processing, applicants first set forth Table 1 below.

TABLE 1

| | | Fat Charge | | | | | | | | |
|---|---|---|---|---|---|---|---|---|---|---|
| | | Example 1 (80/20) | | | Example 2 (85/15) | | | Example 3 (90/10) | | |
| | | Sample | | | | | | | | |
| | | 0% | 7% | 10% | 0% | 7% | 10% | 0% | 7% | 10% |
| | | K Soap | K Soap | K Soap | K Soap | K Soap | K Soap | K Soap | K Soap | K Soap |
| Total fatty matter, % | | 69.25 | 69.01 | 68.91 | 69.39 | 69.16 | 69.06 | 69.58 | 69.35 | 69.25 |
| Saponification | NaOH, % | 100.00 | 93.00 | 90.00 | 100.00 | 93.00 | 90.00 | 100.00 | 93.00 | 90.00 |
| | KOH, % | — | 7.00 | 10.00 | — | 7.00 | 10.00 | — | 7.00 | 10.00 |
| Na Soap | | 75.13 | 69.64 | 67.29 | 75.29 | 69.79 | 67.44 | 75.49 | 69.79 | 67.44 |
| K Soap | | — | 5.52 | 7.68 | — | 5.53 | 7.89 | — | 5.75 | 8.11 |
| Glycerine | | 8.19 | 8.16 | 8.15 | 7.83 | 7.65 | 7.79 | 7.55 | 7.36 | 7.55 |
| Other Ingredients | | Up to | Up to | Up to | Up to | Up to | Up to | Up to | Up to | Up to |
| | | 20% | 20% | 20% | 20% | 20% | 20% | 20% | 20% | 20% |
| IV | | 32.00 | 32.00 | 32.00 | 32.00 | 32.00 | 32.00 | 32.00 | 32.00 | 32.00 |
| Oil Blend | PO | — | — | — | — | — | — | — | — | — |
| | PSO | 80 | 80 | 80 | 85 | 85 | 85 | 90 | 90 | 90 |
| | PKO | 20 | 20 | 20 | 15 | 15 | 15 | 10 | 10 | 10 |

PO = palm oil (triglyceride blend within IV of 55)
PSO = palm stearine oil (triglyceride blend within IV of 33 to 35)
PKO = palm kernel oil (triglyceride blend within IV of 18)

For purposes of our invention, tallow could be used in place of PO and/or PSO; and coconut could be used in place of PKO.

In each of Examples 1-3, 0% potassium soap is used as a baseline value. Bars with some potassium soap (7% and 10%) potassium hydroxide used to make potassium soaps within ranges of the invention were also tested. The IV value remains constant within each example.

The effect of potassium soap substitution on bar hardness (and on ability to obtain desired hardness range) is shown in Table 2 below:

TABLE 2

| | 80/20 | | | 85/15 | | | 90/10 | | |
|---|---|---|---|---|---|---|---|---|---|
| IV (cg l₂/g) | 32 | | | 32 | | | 32 | | |
| KOH (%) | 0% | 7% | 10% | 0% | 7% | 10% | 0% | 7% | 10% |
| NaOH (%) | 100% | 93% | 90% | 100% | 93% | 90% | 100% | 93% | 90% |
| Hardness (Kg @ 40° C.) | 5.21 | 4.48 | 3.72 | 5.83 | 4.81 | 2.86 | 6.39 | 5.23 | 3.85 |

The 80/20, 80/15 and 90/10 figures refer to the composition of the oils as set forth at bottom of Table 1. This 80/20 refers to oil blend derived from 80% PSO (IV 33 to 35) and 20% PKO (IV of 18). That is, weight ratio is 80% PSO to 20% PKO.

As seen in Table 2, when 7 or 10% potassium hydroxide is added to various oil blends, hardness (as measured in final extruded bars) can be controlled in order to obtain desired value (e.g., 3 to 5 Kg measured at 40° C.). If potassium levels are too high, it can be seen that bars will become too soft (e.g., below 3 Kg). Because some blends are harder than others (e.g., 90/10 is harder than 80/20), the exact range or amount (within 5 to 15% potassium soap range of final bar) varies but can be readily determined by one skilled in the art as demonstrated from Table 2 (by varying amount of potassium hydroxide used to form soaps). Specifically, the hardness value is measured and used to calculate whether potassium hydroxide level (and resulting soap level) should be moved slightly up or down.

For example, at a uniform IV of 32, slightly different amounts of potassium hydroxide are needed depending on composition of oils (e.g. 80/20 versus 90/10. Thus, 90/10 oils typically will have longer chain oils than 80/20 and make the resultant bar slightly harder. As such, more potassium soap (as percent of final bar) is needed to bring 90/10 bar into preferred hardness range.

In preferred embodiments, the fatty acid soap (50% to 90% of bar) comprise 5 to 15% potassium soap, based in weight of the bar; and the soaps are formed from oil or oil blend which has average IV of 0 to 37, wherein said oil or oil blend is selected from the group consisting of palm oil (PO), palm stearine oil (PSO to PKO) and palm kernel oil (PKO). In one preferred embodiment, ratio of PSO to PKO is about 78/22 to 82/18.

In one preferred bar, potassium soap is at a level of 5 to 12% by wt. and ratio of oils used (e.g., PSO to PKO) to form soap is 78/22 to 82/18. In another preferred bar, level of potassium soap is 5 to 9% and ratio of tallow to coconut used to make the bar is 82/18 to 88/12. In another preferred bar, level of potassium soap is 8 to 12% by wt. and ratio of tallow to coconut (or PSO to PKO) is 87/13 to 93/7.

As seen in FIGS. 1, 2 and 3, the use of potassium soap enhances lather and does not affect rate of wear value or objective mush values. With improved lather, oils with lower IV can be used. Thus, we obtain bars which have long wear and have mush attributes associated with low IV starting oil and good lather correlated with high IV bars. As previously indicated, such bars extrude well (defined by hardness) but without excessive cracking,

In FIG. 1, for example, we used soaps made from oils having various chain length distribution (80/20, 85/15, 90/10), all having IV of 39 as control examples A, B, and C. Typically, compared to bars made from oils of lower IV but no potassium saponification (Ex. 4, 7, 10), lather was a bit lower. However, when saponified with 7 or 10% potassium ions, resulting bars (5-6 vs. A; 8-9 vs. B; 11-12 vs. C) all surprisingly showed lather far more comparable to the control bars made from oils of higher IV which would be expected to have far more lather.

A summary of the Examples shown in the FIG. 1 is seen in Table 3 below:

TABLE 3

| Examples | Fat Blend | IV | KOH |
|---|---|---|---|
| Example A | 80/20 | 39 | 0% |
| Example 4 | | 32 | 0% |
| Example 5 | | 32 | 7% |
| Example 6 | | 32 | 10% |
| Example B | 85/15 | 39 | 0% |
| Example 7 | | 32 | 0% |
| Example 8 | | 32 | 7% |
| Example 9 | | 32 | 10% |
| Example C | 90/10 | 39 | 0% |
| Example 10 | | 32 | 0% |
| Example 11 | | 32 | 7% |
| Example 12 | | 32 | 10% |

Similar to FIG. 1, FIG. 2 shows that when same bars as shown in Table 3 are saponified with 7 or 10% potassium salt, the resulting bars (14-15 vs. D; 17-18 vs. E; 20-21 vs. F) showed lower/better results in the Rate of Wear test compared to the control bars made from oils of higher IV.

Again, similar to FIG. 1, FIG. 3 shows that when bars as shown in Table 3 are saponified with 7 or 10% potassium salt, the resulting bars (23-24 vs. G; 26-27 vs. H; 29-30 vs. I) showed lower/better results compared to the control bars made from oils of higher IV, with lower Objective mush values.

### Example 31-38

In order to assess the performance of fragrance of bars of the invention, applicants prepared the following bars as set forth in Table 4 below.

TABLE 4

| | J | 31 | 32 | K | 33 | 34 | L | 35 | 36 |
|---|---|---|---|---|---|---|---|---|---|
| Soap | 80/20 | 80/20 | 80/20 | 85/15 | 85/15 | 85/15 | 90/10 | 90/10 | 90/10 |
| base | | | | | | | | | |
| IV | 39 | 30 | 20 | 39 | 30 | 20 | 39 | 30 | 20 |
| KOH, % | 0 | 5.5 | 6.5 | 0 | 6.2 | 7.3 | 0 | 6.5 | 7.5 |
| Fragrance | 1.3 | 1.3 | 1.3 | 1.3 | 1.3 | 1.3 | 1.3 | 1.3 | 1.3 |
| (Chiffon | | | | | | | | | |
| Petal), % | | | | | | | | | |
| HS over | 12.1 ± | 13.4 ± | 17.2 ± | 12.3 ± | 15.1 ± | 17.2 ± | 14.5 ± | 17.5 ± | 18.5 ± |
| bar | 0.9 | 1.0 | 1.1 | 1.1 | 1.0 | 1.2 | 0.90 | 0.08 | 1.1 |
| HS over | 3.5 ± | 4.0 ± | 5.7 ± | 3.2 ± | 4.3 ± | 6.5 ± | 3.1 ± | 4.0 ± | 6.6 ± |
| 30× | 0.25 | 0.30 | 0.55 | 0.25 | 0.35 | 0.45 | 0.40 | 0.35 | 0.65 |
| dilution | | | | | | | | | |
| HS over | n/a | n/a | n/a | n/a | n/a | n/a | 1.35 ± | 1.60 ± | 2.4 ± |
| vitro-skin | | | | | | | 0.08 | 0.11 | 0.11 |

Bars 31, 32, 33, 34, 35, 36 were prepared as per invention wherein the IV values are 30 and 20 and the saponification (or neutralisation) was conducted with a mixture of sodium hydroxide and potassium hydroxide. Bars J, K, and L are comparative bars having IV value 39 and no potassium soap. As seen from the data above the bars of the invention show higher fragrance head space over bar, and over the 30× bar dilution, which implies greater bloom during the use. Applicant also measured the head space over vitro-skin washed with bars L, 35, and 36. One can see that bars 35 and 36 according to the invention deliver more fragrance to vitro-skin as compared to comparative (conventional) bar L.

In order to compare the performance of essential oils, in particular, used for anti-bacterial bars, applicants prepared bars with thymol and terpineol. Bars 37 and 38 are prepared according to the invention, and bar M is a comparative bar. One can see that the head space over 30 times diluted bars is significantly higher in bars with lower IV value according to the invention.

TABLE 5

| | | M | 37 | 38 |
|---|---|---|---|---|
| Soap base | | 90/10 | 90/10 | 85/15 |
| IV | | 39 | 32 | 32 |
| KOH | | 0 | 7.0 | 7.0 |
| Terpineol, % | | 0.25 | 0.25 | 0.25 |
| Thymol, % | | 0.10 | 0.10 | 0.10 |
| HS over 30x | Terpineol | 1.12 ± 0.08 | 1.56 ± 0.06 | 1.40 ± 0.07 |
| dilution, r.u. | Thymol | 0.23 ± 0.03 | 0.43 ± 0.03 | 0.34 ± 0.03 |

### Example 39

Applicants saponified bars of varying IV to determine the level of potassium hydroxide needed to achieve preferred hardness range. Oil blends used for all bars were 85/15 PSO/PKO. Results were set forth in Table 6 below:

TABLE 6

| IV | 5 | 10 | 15 | 20 | 25 | 30 |
|---|---|---|---|---|---|---|
| KOH % | 13.00 | 10.70 | 10.20 | 9.50 | 9.00 | 8.10 |
| Hardness | 4.70 | 4.38 | 3.80 | 4.74 | 4.53 | 4.06 |

As seen, using bars from starting 85/15 oils, bars of measured IV 5 to 30 achieved preferred hardness values at KOH level ranging from 8.10 to 13.00.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A method of forming a bar which method comprises the steps of:
(a) selecting oil having an IV of from 0 to 37;
(b) saponifying the oil with potassium to provide 5% to 15% by wt. of total bar potassium soap; and
(c) extruding the soap of step (b) to form solid bar.

14. The method according to claim 13 wherein said bar hardness is within the range of 3.0 to 5.0 Kg when measured at 40° C. using 15 mm penetration.

15. The method according to claim 13, wherein the bar has a cracking value of 0 to 3.

16. The method according to claim 13, wherein the bar has wear and mush benefits associated with the use of starting oils having an IV of 0 to 37 and lather benefits associated with the use of starting oils having an IV of greater than 37.

17. The method according to claim 13, wherein the starting oil or oils is selected from the group consisting of tallow oil, coconut oil and mixtures thereof.

18. The method according to claim 13, wherein the fatty acid soap comprises 5 to 12% by wt. potassium soap based on wt. % of final composition and ratio of tallow to coconut is 78/22 to 82/18.

19. The method according to claim 13, wherein the starting oil or oils is selected from the group consisting of palm stearin oil (PSO), palm kernel oil (PKO) and mixtures thereof.

20. The method according to claim 13, wherein the fatty acid soap comprises 5 to 12% by wt. potassium soap based on overall wt. of bar composition and ratio of PSO to PKO is 78/22 to 82/18.

21. The method according to claim 13, wherein the fatty acid soap comprises 5 to 9% by wt. potassium soap based on wt. % of the bar composition and ratio tallow to coconut is 82/18 to 88/12.

22. The method according to claim 13 wherein the fatty acid soap comprises 8 to 12% by wt. potassium soap based on wt. % of the bar composition and ratio of tallow to coconut is 87/13 to 93/7.
